(19) United States
(12) Patent Application Publication
(10) Pub. No.: US 2002/0104090 A1
(43) Pub. Date: Aug. 1, 2002

(54) System and method for interactive advertising

(76) Inventor: Armando Paul Stettner, Woodinville, WA (US)

Correspondence Address: Dennis M. de Guzman, BLAKELY, SOKOLOFF, TAYLOR & ZAFMAN LLP, 7th Floor, 12400 Wilshire Boulevard, Los Angeles, CA, 90025, US

(21) Appl. No.: 09/747,424

(22) Filed: Dec. 21, 2000

Related U.S. Application Data
(60) Provisional application No. 60/224,736, filed on Aug. 10, 2000.

(51) Int. Cl. H04N 7/16; H04H 9/00; H04N 7/173; H04N 7/025; H04N 7/10; G06F 3/00; H04N 5/445; G06F 13/00

(52) U.S. Cl. 725/60; 725/24; 725/13; 725/34

(57) ABSTRACT

An advertising service presents an interactive advertisement to a customer, such as via a television commercial. If the customer indicates an interest in the advertised product by responding to the advertisement, then the advertising service or other mechanism identifies the customer, correlates the customer to a merchant, and then automatically connects the customer to the merchant (or triggers connection of the merchant to the customer). The customer may be identified by extracting an identification number, address, or other identifying information associated with a client terminal that the customer used to respond to the advertisement. Correlation of the customer to the merchant may be performed by a database lookup to match customer information to merchant information. Thereafter, the merchant can be notified by the advertising service to contact the customer to fulfill the customer's response in a personalized and interactive manner.

### CROSS-REFERENCE TO RELATED APPLICATIONS

The present application claims the benefit of U.S. Provisional Patent Application Serial No. 60/224,736, filed Aug. 10, 2000, entitled “USER INTERFACE TO TELEVISION BROADCASTS AND INTERNET CONTENT,” which is incorporated herein by reference.

### BACKGROUND OF THE INVENTION

1. Field of the Invention

The present invention relates generally to communication systems and advertising, and in particular but not exclusively, relates to fulfillment of responses to advertisements sent over a communication system, such as an interactive video casting system.

2. Background Information

An important business element in the production and distribution of television or radio programming is revenue received from manufacturers and service providers who pay to advertise their products. The ubiquitous television commercial is the manifestation of this enterprise. The survival of a television program is heavily dependent on the advertising revenue that can be realized from the television program. Advertisers in turn rely on the ability of the television program to draw viewers who then become potential purchasers of the advertised products. An effective commercial is one that captures the viewer's attention in a lasting manner and that ultimately results in the purchase of goods and/or services.

In addition to advertisements presented as radio or television commercials, advertisements are also provided through other media. Examples include billboards, pre-recorded telemarketing calls, banner advertisements on Internet web sites, printed media such as “junk mail” or newspaper advertisements, and the like. These forms of advertisements typically invite the potential customer to dial a telephone number or mail a form in order to purchase the product or to obtain additional information.

Advertisements do not always effectively result in a purchase for a variety of reasons. Among these reasons are that many advertisements provide insufficient interaction with the potential customer or mechanisms to make responding to the advertisements more convenient for the customer. A radio or television commercial for a local restaurant that provides home delivery serves as an illustration. In the commercial, the local restaurant may advertise a type of pizza, followed by a telephone number that the potential customer can call to place an order. If the potential customer is interested in having pizza delivered to his home from that restaurant, the customer has to stop what he is doing, write down or try to remember the telephone number (or address) of the restaurant, dial the telephone number, and then perhaps eventually place an order with an operator at the restaurant who answers the telephone call (assuming that the customer is not kept on hold while other orders are taken). Similar types of multiple tasks need to be completed by potential customers if these customers wish to respond to other forms of advertisements, such as billboards, printed media, etc. In short, these forms of advertisements involve a lengthy and cumbersome process that needs to be performed by the potential customer. Such advertisements make it inconvenient to potential customers to respond to advertisements, thereby ultimately reducing the customers' inclination to begin or complete a purchase.

Accordingly, improvements are needed in the advertisement of products and in the fulfillment of customer responses to the advertisements.

### SUMMARY OF THE INVENTION

The above-described problems relating to advertisements are addressed by the present invention. The present invention comprises a system and method for interactive advertising. In accordance with an embodiment of the invention, an advertising service presents an interactive advertisement to a customer, such as via a television commercial. If the customer indicates an interest in the advertised product by responding to the advertisement, then the advertising service or other mechanism detects the customer's response, identifies the customer, correlates the customer to a merchant, and then automatically connects the customer to the merchant (or triggers connection of the merchant to the customer). Thereafter, the merchant can fulfill the customer's response in a personalized and interactive manner. An aspect of the invention provides a method to detect a response, to an interactive advertisement, sent from a client terminal of a customer. The method identifies customer information from the detected response. The identified customer information is correlated to merchant information to identify a specific merchant, and notification of the identified specific merchant is triggered to allow communication between the customer and the specific merchant.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 shows an example of an interactive video casting system that can implement interactive advertising in accordance with an embodiment of the invention.

FIG. 2 shows an example of an interactive video casting system that can implement interactive advertising in accordance with an embodiment of the invention.

FIG. 3 shows an example of an interactive video casting system that can implement interactive advertising in accordance with an embodiment of the invention.

FIG. 4 depicts an interactive advertisement that can be presented to a customer via the systems of FIGS. 1-3 in accordance with an embodiment of the invention.

FIG. 5 is a flow diagram depicting a sequence of events in connection with providing, and fulfillment of responses to, the interactive advertisement of FIG. 4.

FIG. 6 is a flow diagram depicting a video and audio capture and communication technique that can be used to fulfill a customer's response to the interactive advertisement of FIG. 4.

### DETAILED DESCRIPTION OF THE ILLUSTRATED EMBODIMENTS

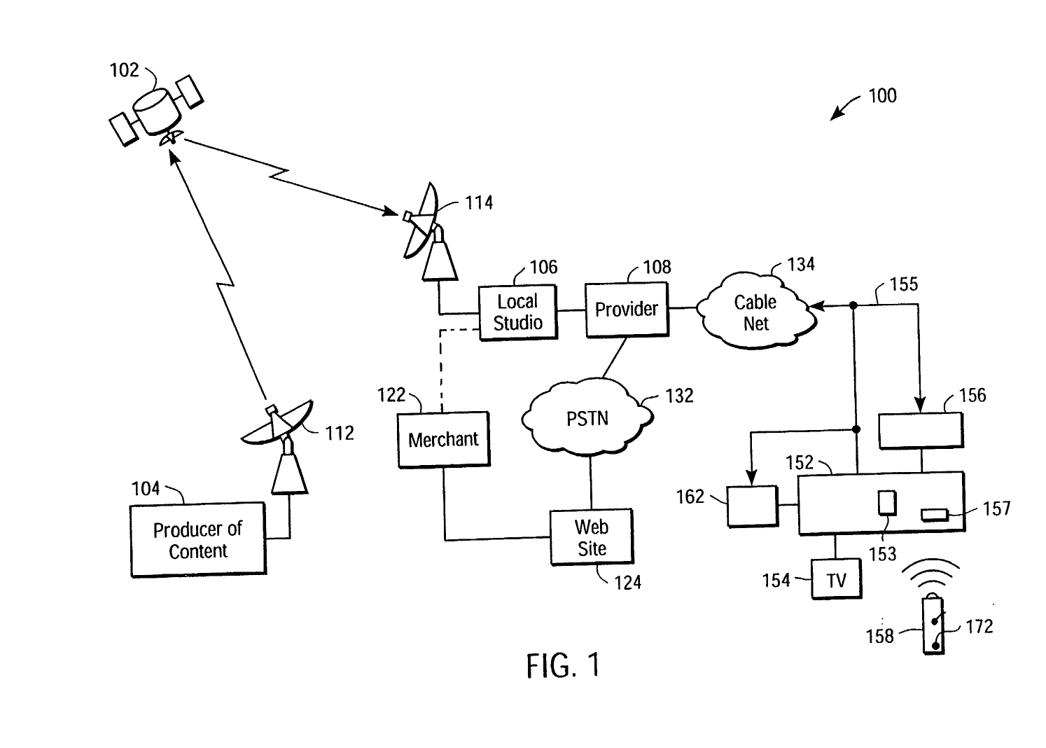

Embodiments of a system and method for interactive advertisement are described herein. In the following description, numerous specific details are provided, such as the description of system components in FIGS. 1-3, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As an overview, an embodiment of the invention provides a form of advertising (and the resulting fulfillment of customer responses to the advertisement) that can be thought of as “interactive advertising.” For an advertisement for a national or well-known product (e.g., goods or services), for instance, an embodiment of the invention correlates a potential customer's response to the advertisement to a specific local merchant (such as a local retailer, distributor, or service provider) for fulfillment of the customer's response. Such fulfillment can include the service of the customer's order or the providing of additional information. In some embodiments, the merchant that fulfills the customer's response need not necessarily be local, and instead can be located anywhere and still fulfill the customer's response.

In an embodiment, an advertising service presents an interactive advertisement to a customer, such as via a television commercial. If the customer indicates an interest in the advertised product by responding to the advertisement, then the advertising service or other mechanism detects the customer's response, identifies the customer, correlates the customer to a merchant, and then automatically connects the customer to the merchant (or triggers connection of the merchant to the customer). Thereafter, the merchant can fulfill the customer's response in a personalized and interactive manner.

For simplicity of explanation and for illustrative purposes, an embodiment of the invention will be described herein as being implemented in an interactive video casting system, such as an interactive television system. It is understood that other embodiments of the invention can be implemented in other advertising media, such as computer networks, radio, telephone, or other media or combinations thereof that are capable of interactive advertising as disclosed or taught herein. Where appropriate, descriptions of such alternative or additional implementations are provided herein.

FIG. 1 shows an example arrangement of an interactive video casting system 100 that can implement interactive advertising in accordance with an embodiment of the invention. A production company 104 produces programming content for transmission to viewers. The transmission is sent over an uplink channel to a satellite 102. The satellite 102 then transmits the programming content over a downlink channel to a local studio 106. The local studio 106 can insert additional programming (e.g., regional programming) and/or advertisements as needed into the programming content. In this regard, the local studio 106 can act as an “advertising service” for interested or subscribing merchants.

The content with the insertions is then transmitted from the local studio 106 to a cable service provider 108. In an embodiment, the television program may be downloaded to a receiving station, such as a head-end (H/E) of the cable service provider 108, rather than or in addition to the local studio 106. A reverse channel from the cable service provider 108 to the local studio 106 is provided so that the local studio 106 can insert additional programming content or advertisements, and feed the television signal back to the cable service provider 108. The cable service provider 108 then delivers the television signal over a cable network 134 to cable subscribers. In addition or alternatively to the local studio 106, the cable service provider 108 can also act as an advertising service that is also capable to insert advertisements (and/or other information related to the advertisements, such as triggers, data to identify the merchant, time of broadcast of the advertisement, address of the merchant, etc.) into the television signal.

The cable network 134 is provided by the cable service provider 108 to distribute the programming content to cable subscribers. A set top box (STB) 152, located on the premises of a cable television subscriber (e.g., a user or customer), receives the programming content or television signal, and delivers the television signal to the subscriber's television set 154. Alternatively or in addition, the television signal can be broadcast over a wireless medium and received by a traditional aerial antenna or by a satellite dish, and then delivered to the set top box 152. Alternatively or additionally, features and functionality of the set top box 152 may be integrated into a type of advanced television or other display device.

Moreover, embodiments of the invention can use other types of broadcast media, including but not limited to, digital cable systems, satellite, very-high-data-rate digital subscriber line (VDSL), web casts, etc. The features provided by the television set 154 can also be provisioned, in one embodiment, by a personal computer (PC) suitably configured with an adapter to convert television signals into a digitized format, and then to deliver the television signals to the video portion of the computer for display. It is noted that the invention is not limited to any one configuration of display hardware, as embodiments of the invention will work equally well using alternative reception and display arrangements.

In accordance with an embodiment of the invention, a connection to a communication network is provided for the cable subscriber. In one embodiment, the connection can be made via a cable modem 156 over a bi-directional communication link 155 to a cable modem termination system within the cable provider's 108 equipment. The connection continues to a data communication network, such as the Internet, by way of a public switched network (PSTN) 132. The PSTN network 132 is provided herein as an example, and it is understood that other types of networks may be used for connectivity to the Internet. A cable modem arrangement can be used because of its high bandwidth capability. In situations where some cable companies are not equipped to provide cable modem service to their customers, various other arrangements can be made. For example, a conventional modem connection can be used to access the Internet over a telephone line.

As another example, Internet access can be gained over a DSL connection or an integrated services digital network (ISDN) connection using a telephone line. Wireless systems are also available for providing Internet access. In one embodiment, downstream data transmission can occur via cable or satellite, and upstream data transmission can occur via a telephone line. It is also to be appreciated that the customer may have other communication devices, such as a telephone or a separate PC, which are capable of providing communications with a merchant 122 via the PSTN 132 or other data communication network, independently or in conjunction with a television signal that is received by the set top box 152.

It is noted that the Internet is chosen as an example of a data communication network because it is a well-established network, and connectivity to the Internet is easily made. However, it is noted that a global communication network, such as the Internet, is not required to practice other embodiments of the invention. A locally provided and maintained communication network may be used in an embodiment.

Continuing with FIG. 1, the set top box 152 can include a transceiver 157, such as an infrared (IR) or radio frequency (RF) transceiver, that can exchange signals with a remote control unit 158 or other user input device. The set top box 152 can be a component that is separate from the television set 154 as shown in FIG. 1, or its features can be built into circuitry of the television set 154 (e.g., an interactive television set). The set top box 152 enables a viewer to select a television program to view and then delivers the television program to the television set 154.

In an embodiment, the set top box 152 can be provided with an identification number or address that uniquely identifies the set top box 152 within the system 100 from other set top boxes. Such an identification number or address can be installed by a manufacturer (e.g., “hard-coded” into the set top box 152 at the time of manufacture, for example), or provided/assigned when the customer subscribes to interactive television services from the cable service provider 108. An address for the set top box 152 can include an Internet Protocol (IP) address, uniform resource locator (URL) address, or other address. As will be described later below this identification information can be used in an embodiment of the invention to allow the advertising service or the merchant 122 to identify the customer when the customer sends a response to an advertisement from the set top box 152.

A storage unit 162 can also be coupled to or be a part of the set top box 152. The storage unit 162 can comprise a machine-readable storage medium such as a cache, buffer, memory, diskette, compact disk, tape, or the like and their associated hardware, in one embodiment. In another embodiment the storage unit 162 can include a video cassette recorder (VCR). In another embodiment, the storage unit can include a hard disk such as a digital or personal video recorder (DVR or PVR).

As noted above, the local studio 106 can insert additional programming into the received transmission, for example, to provide cable content that includes locally provided channels. The programming is then distributed to customers over the cable network 134. In addition to local program insertion, the local studio 106, cable service provider 108, or other party can insert advertising content. Product supplemental information relating to the advertising for participating merchants 122 can also be inserted. Product supplemental information can include information relating to the goods or services being advertised in the commercial. In addition to goods and services, coupons and other information services can be made available to the viewer, which in one embodiment can be obtained via the merchant's 122 web site 124 on the Internet. Triggers, such as Advanced Television Enhancement Forum (ATVEF) triggers, which are related to the web site 124 and/or to its contents, can be continuously updated as the television broadcast is being received. The web site 124 can be provided from a server, which can also send information to the set top box 152 in connection with fulfilling customer responses to advertisements. Such information sent from the server to the set top box 152 or other terminal of the customer can include, but not be limited to, an email, an order form, requested product information, confirmation of orders, or other information in electronic format capable of being sent to the customer.

In an embodiment of the invention, the merchant 122 may subscribe/register or otherwise make itself known to the local studio 106, the cable service provider 108, or other advertising service. This registration allows the advertising service to provide advertisements on behalf of the merchant 122 and to subsequently correlate customer responses to the interactive advertisements to the merchant 122. This registration of the merchant 122 is represented in FIG. 1 by a dashed line from the merchant 122 to the local studio 106. The dashed line also represents that the local studio 106 (or other advertising service) can notify the merchant 122 of customer responses to interactive advertisements, with the notification capable of being sent via the PSTN 132 or other communication network/medium.

In accordance with an embodiment of the invention, a participating merchant list 153 may be maintained. As the name implies, this list permits participating merchants 122 to provide their product supplemental information to the viewer. The participating merchant list 153 may be provided to and stored in the set top box 152. Alternately or additionally, the participating merchant list 153 may be stored at a head-end or other system of the cable service provider 108, or at a third party system. In this embodiment, the participating merchant list 153 may operate as a “white” list which allows transmission of triggers from authorized merchants and filters out other triggers. In another embodiment, a “blocked” or “black” list may be maintained at the set top box 152 or elsewhere. Such a blocked list filters out undesirable triggers and may be created and/or maintained by the cable service provider 108. Alternately or additionally, such a blocked list may be edited by an end user.

Various techniques for carrying the product supplemental information can be used. For example, triggering, announcement, or resource information can be included and sent using the ATVEF standard, in a manner known by those skilled in the art. For instance, a uniform resource locator (URL) address can be embedded in the broadcast stream. Other standards that may be used include triggering mechanisms from Wink and WorldGate. Another technique is to embed code or a script in the stream that runs on the client (e.g., at the set top box 152) to provide the information and/or purchase experience.

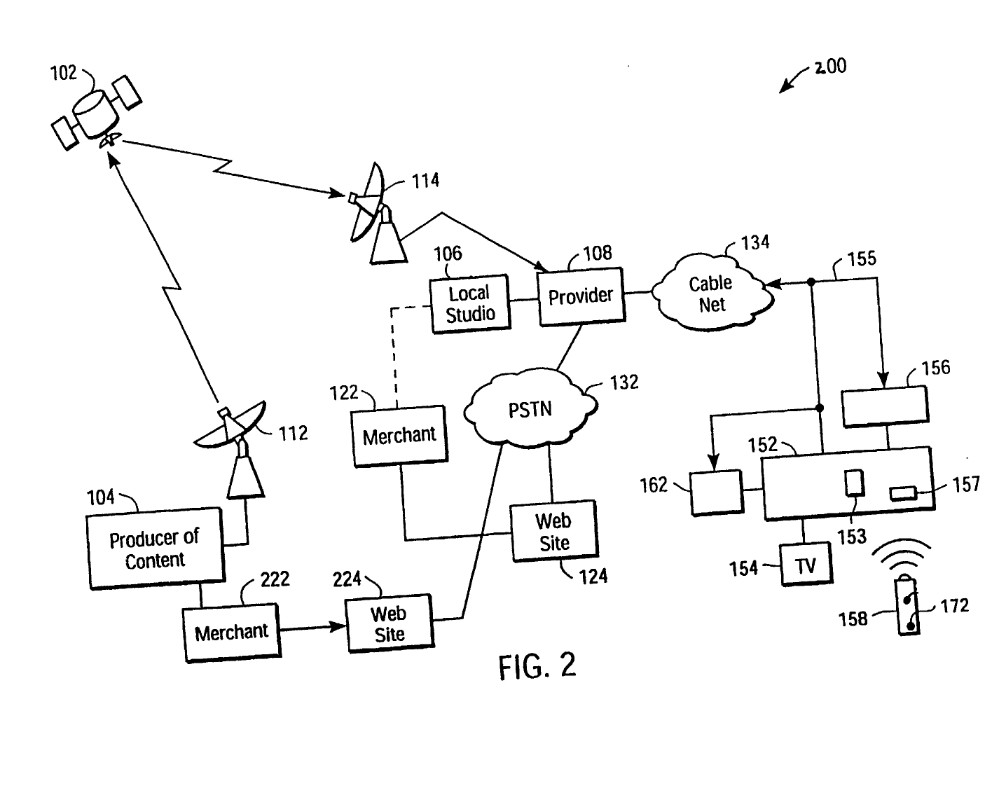

As noted above, the triggers, resources, or announcements can be inserted by the originating broadcaster 104, by a local studio 106, by the cable service provider 108, or by another party. FIG. 2 shows another example of an interactive video casting system 200 and illustrates another point of insertion of the product supplemental information. Here, a merchant 222, operating a web site 224, is located such that commercial insertion is made prior to the uplink transmission to the satellite 102. The merchant 222 can also be subscribed similarly as the merchant 122 and be capable of fulfilling customer responses that are directed to it.

As noted above, Internet access is not necessary to practice the invention. A locally provided network may be within the scope of the invention as claimed. The cable provider 108 can supply the foregoing features, for example, by providing a web site or “walled garden” that is accessed by its subscribers. In such a case, the cable provider 108 serves as an intermediary and submits the purchases to the actual merchants 122 or 222.

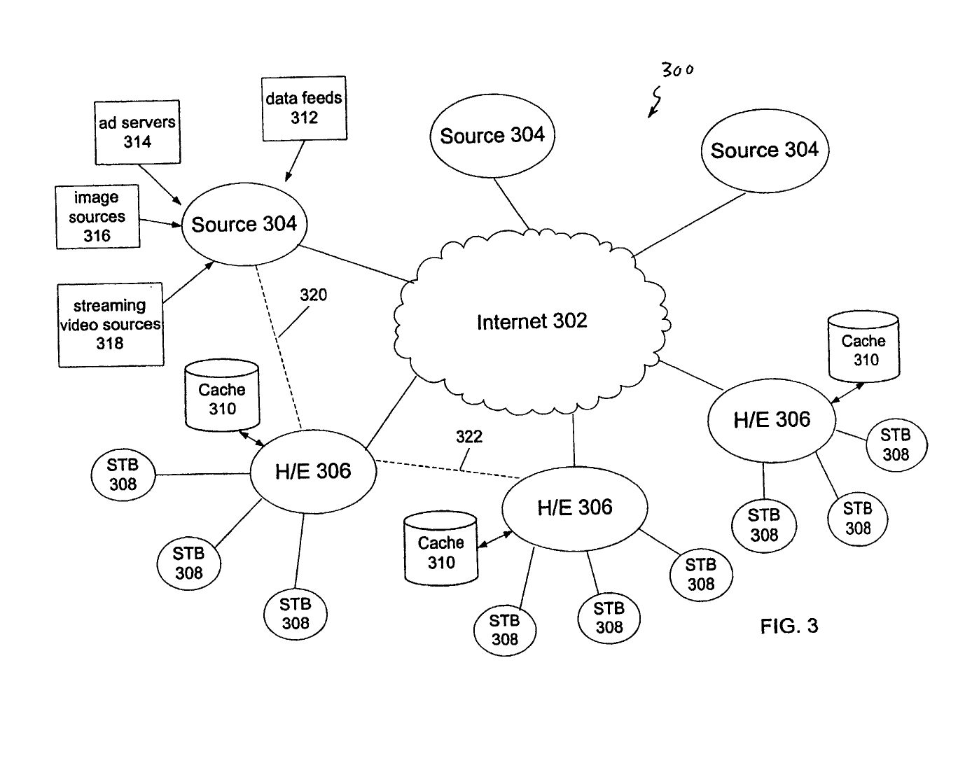

FIG. 3 shows another example of an interactive video casting system 300 that can implement interactive advertising in accordance with an embodiment of the invention. The system 300 can be similar to or combined with the systems 100 and 200 shown in FIGS. 1 and 2, respectively. In accordance with an embodiment of the present invention, the system 300 can be integrated with a cable television distribution system. The system 300 includes an Internet 302, a plurality of content sources 304, a plurality of distribution centers (depicted as the head-ends or H/Es 306), and a plurality of client terminals 308 (depicted as set top boxes). In addition, a content source 304 is depicted as receiving data from data feeds 312, advertisement servers 314, image sources 316, and streaming video sources 318.

The plurality of content sources 304 is coupled to the Internet 302. For example, a content source 304 may comprise a web site portal such as Go2Net.com, or a news web site such as CNN.com, or other types of sources. Each content source 304 may have various data feeds 312, servers 314, and sources 316/318 coupled to it. In an embodiment, the content source 304 can include an advertising service, and can be embodied in parties such as a local broadcaster or a multiple system operator (MSO), similar to the local studio 106 and cable service provider 108, respectively, of FIGS. 1-2.

News or stock quote feeds 312 may be fed into the content source 304. Servers 314 may provide advertisements for insertion into multimedia content delivered by the content source 304. Sources 316/318 may provide images 316, streaming video 318, and other content to the content source 304. Various other feeds, servers and sources may also be coupled to the content source 304 of FIG. 3, or coupled to the production company 104, cable network 134, web sites 124 and 224, or to other components of the systems shown in FIGS. 1 and 2.

The Internet 302 comprises a network of networks and is well known in the art. Communications over the Internet 302 can be accomplished using standard protocols such as transmission control protocol/internet protocol (TCP/IP), hypertext transfer protocol (HTTP), file transfer protocol (FTP), or other protocols. The Internet 302 is coupled to the plurality of distribution centers 306, and each distribution center 306 is in turn coupled to a plurality of client terminals 308, which may comprise a set top box, a PC, an interactive television set, or another type of communication device or display device.

In alternative or in addition to the Internet 302 being used to distribute multimedia content from the content sources 304 to the distribution centers 306, communications channels or networks 320 apart from the Internet 302 may couple one or more content sources 304 to one or more distribution centers 306. One example of such an alternate path for communications is illustrated by a first dashed line 320 in FIG. 3. Alternately or additionally, peering connections may exist between distribution centers 306. One example of such peering is illustrated by a second dashed line 322 in FIG. 3. Other configurations are also possible and are included within the scope of the present invention.

Caches 310 may be provided at (or coupled to) the distribution centers 306. Such caches 310 may be used to increase the performance in the delivery of multimedia content to the client terminals 308. For example, larger files for video and other high bandwidth content may be stored in such caches 310, which may be closer to the client terminals 308 than to the content sources 304. In addition, reliability and guaranteed bandwidth may be provided because the Internet 302 is not in-between such caches 310 and the client terminals 308.

The distribution centers 306 (e.g., head-ends) may include a server, in one embodiment, to direct a customer's response to an advertisement to the web site 124 of the merchant 122, for example. The distribution center 306 may also include, or be communicatively coupled to, a database (having merchant, customer, or advertising/broadcast information stored therein), such that when a response from the client terminal 308 is received, a database lookup can be performed by the server or software to identify the client terminal 308 that responded, to correlate the response with the advertisement that it responded to and with the corresponding merchant, and to trigger notification of the corresponding merchant to contact the customer or client terminal 308 to fulfill the response.

The server may also include software to redirect a browser of the customer's client terminal 308 to the merchant's web site, for example, if the merchant is a type that fulfills responses via its web site. In this manner, the merchant can identify the customer after redirection and begin fulfillment of the customer's response. In another embodiment, the distribution center 306 can include or be coupled to a communication device/equipment to notify the merchant after the customer's response has been detected and after the customer has been identified. Such equipment can include telephone interfaces to notify the merchant via an automated telephone message or a facsimile, an email interface to provide an email message to the merchant, a wireless device interface to provide a notification to the merchant via a wireless medium, etc.

In accordance with one embodiment of the invention, different or multiple portals may be used to access the information provided through the interactive video casting systems of FIGS. 1-3, based on the type of client terminal being used by the end user. That is, for example, a television portal may be provided for an end user that uses the television set 154 to access the information. A PC portal may be provided for an end user that uses a PC to access the information. Portals can be provided for end users that use cellular telephones, PDAs, audio devices, etc. to access the interactive video casting systems of FIGS. 1-3.

Such portals may be provided in several possible ways. In one embodiment, the client terminal (e.g., the end user's display device or audio device) can be suitably configured with an adapter that includes hardware and software. The adapter converts the television signals, the Internet or web page content, or other information provided from the interactive video casting system into a digitized format or other format that is compatible with the operational features of the client terminal.

In another embodiment, the cable provider 108 can deliver signals having different formats to the various client terminals, with the client terminals not necessarily having special adapters. Therefore, as an example, the cable provider 108 or other party can generate/deliver information (e.g., television programming, web page content, etc.) having a format that is compatible for end users that receive the information via the television set 154. The cable provider 108 or other party can also generate/deliver the same information (e.g., simultaneously with the television portal on the same communication link, separately on a different communication link, on-demand independent of the television portal, etc.) using a format that is compatible with end users that receive the information via PCs, PDAs, cellular telephones, etc. Thus, the term “interactive video casting system” is used to describe generally a system that can deliver video information over any network and any network-compatible device by broadcasting, multicasting, or unicasting. An “interactive television system” is one type of or one means of access to an “interactive video casting system.”

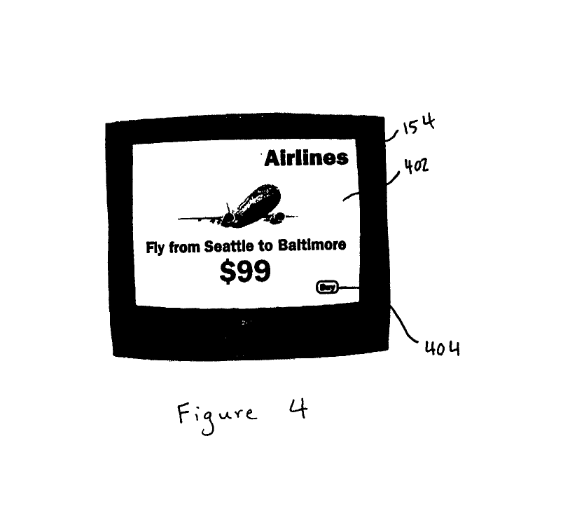

Referring next to FIG. 4, shown at 402 is example of an interactive advertisement that can be presented to a potential customer via the systems of FIGS. 1-3 in accordance with an embodiment of the invention. In the example shown in FIG. 4, the interactive advertisement 402 is a commercial for airline tickets, and it is to be appreciated that other types of broadcast segments may be displayed, such as public service announcements, previews of upcoming programming, “infommercials,” or other programming that can be displayed as part of an interactive video casting transmission. Furthermore, the broadcast segments or the interactive video casting transmission need not be live, and may be pre-recorded, played from a VCR, buffered prior to display, etc. or any suitable combination of these methods.

The interactive advertisement 402 may have an audio or visual (or both) indicator 404 to indicate the availability of enhanced content (e.g., product supplemental information), which the viewer can access using a viewer input device. In the example shown in FIG. 4, the indicator 404 is a “Buy” button that invites the viewer to buy airline tickets. The indicator 404 may be an “Info” button that requests the merchant to provide information about the tickets, there may be multiple indicators 404, or one or more indicators may be used for a combination of purposes (e.g., buying, requesting information, turning enhanced content on/off, activating a menu, etc.), according to various embodiments.

Activation of the indicator 404, by pressing a buy button 174 or an information button 172 of the remote control unit 158 shown in FIGS. 1-2, according to one embodiment, initiates the customer's response to the interactive advertisement 402 by sending a command to the set top box 152 to request fulfillment of the response. Thereafter, the activation of the indicator 404 is detected by the advertising service, the customer is identified, customer information is correlated with the particular interactive advertisement 402 and/or with its corresponding merchant, the corresponding merchant (such as a local affiliate merchant of the airline company that sells the advertised tickets) is notified by the advertising service, and then the merchant communicates with the customer to fulfill the response, all of which can be done in a manner according to various embodiments that will be described as follows, using the systems shown in FIGS. 1-3 as examples.

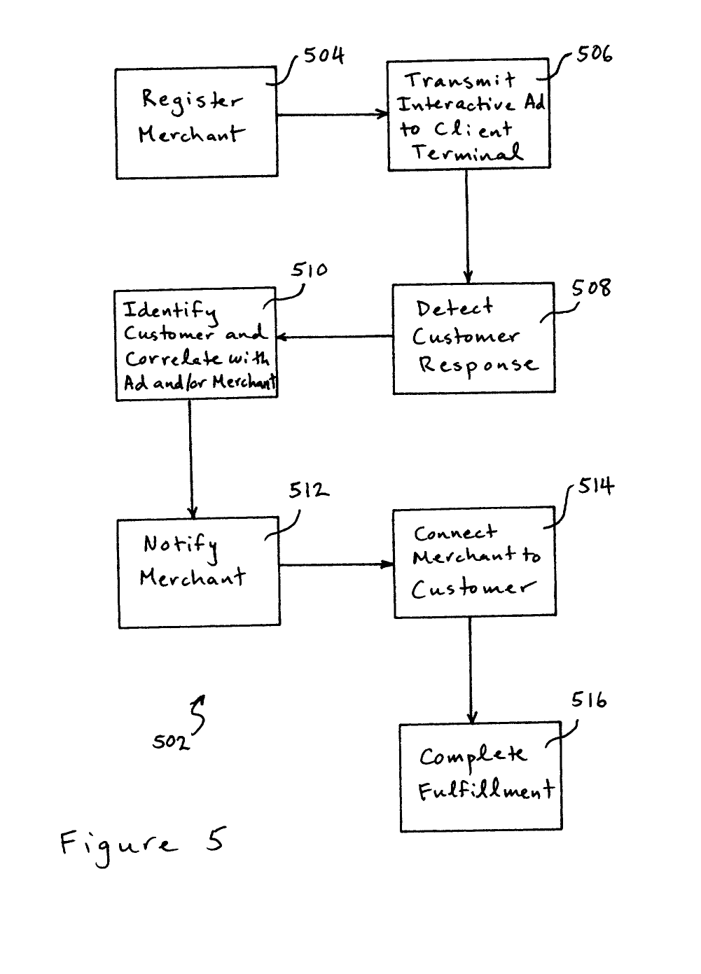

Referring next to FIG. 5, shown generally at 502 is a flow diagram depicting a sequence of events in connection with providing, and fulfilling a customer response to, the interactive advertisement 402 of FIG. 4 or other interactive advertisement. Portions of the flow diagram 502 can be embodied in software or other machine-readable instructions stored in one or more machine-readable media. The machine-readable media can be located in the set top box 152 or other local storage unit, in a head-end 306, in one or more servers in the systems shown in FIGS. 1-3, or in other locations or any suitable combination of these locations.

Beginning at a block 504, the merchant is registered with an advertising service, so that the advertising service can provide interactive advertisements on behalf of the merchant as part of a broadcast. This registration of the merchant, such as the merchant 122, provides the advertising service with the merchant's contact information (e.g., address, telephone number, facsimile number, email address, URL of the web site 124, etc.), the preferred method of contact by the advertising service and/or by the customer, preferred categories of customers (such as customers in a particular geographic area or customers who are determined to be frequent shoppers for a particular product, which can be determined by user profiling techniques), or other information usable by the advertising service in connection with providing advertisements to customers and subsequently directing the customer to the appropriate merchant for fulfillment of responses to the advertisements. The registration of the merchant can also further include, in one embodiment, enablement of a feature to redirect the customer to the merchant 122 when the Buy button indicator 404 is clicked. The merchant information may be stored in a database, such as in the cache 310 or other storage location coupled to the distribution center 306 of FIG. 3.

Next at a block 506, the interactive advertisement 402 is transmitted to a client terminal of the customer, such as to the set top box 152 in one embodiment. In another embodiment, an interactive advertisement may be transmitted via radio, via telephone, via a web site, or via another medium capable to implement interactive advertising.

When the customer that has seen or heard the interactive advertisement 402 decides to order the advertised product, the customer indicates his intention to order or his interest in the advertised product. Such an indication can include, in one embodiment, communication through a tactile input device (such as a keyboard, telephone keypad, or the remote control unit 158). For instance, the user can use the remote control unit 158 to click on the Buy button indicator 404 shown in FIG. 4. If the customer is viewing the interactive advertisement 402 on a PC, then a mouse or other pointing device may be used to activate the indicator 404 or other element of the interactive advertisement indicative of a customer response. The set top box 152 (or the PC) then communicates the customer's response to a head-end or distribution center 306, a server, or other network component of the advertising service. At a block 508, the customer's response is detected, which in an embodiment involves reception of the uplink transmission from the set top box 152.

Next at a block 510, the customer is identified and correlated with the interactive advertisement 402 and/or its corresponding merchant. In an embodiment, the customer can be identified by reading/detecting the contents of the uplink transmission from the set top box 152. That is, the uplink transmission can include the unique identification number of the set top box 152 or its unique network address, and therefore can be used to identify the customer by matching the detected unique identification number with customer and identification information stored in a database. Once identified, additional customer information can be obtained from the database, such as name, telephone number, street address, email address, etc.

Using a database lookup technique in one embodiment, the identified customer can then be correlated to the particular interactive advertisement 402 at the block 510, and/or a characteristic associated with the particular interactive advertisement 402 can be correlated to a specific merchant 122. For instance, an embodiment can correlate the identified customer to the particular interactive advertisement 402 that was clicked, the television channel in which the interactive advertisement 402 was displayed, the time in which the interactive advertisement 402 was displayed and/or when the indicator 404 was clicked, the specific merchant 122 associated with the interactive advertisement 402, etc. Identification of the specific merchant 122 appropriate to service the customer's response can involve a database lookup of local merchants from a list of merchants, based on the customer's geographic location, based on the type of response the customer sent, or other criteria.

Once correlated, the merchant 122 is notified by the advertising service (or other mechanism) at a block 512 to contact the customer. In an embodiment, the merchant 122 is notified implicitly by redirection of the customer's browser or set top box 152 to the merchant's 122 web site 124, for example. This redirection may be performed by a server in the distribution center 306 in one embodiment, and results in a connection of the merchant 122 to the customer at a block 514. This embodiment can be implemented via use of triggers that are embedded with the television transmission having the interactive advertisement 402. When the indicator 404 is clicked, the set top box 152 is redirected to the URL address of the merchant's web site 124, with the URL addresses capable of being obtained from the triggers or from other embedded information that is sent along with the interactive advertisement 402. Once at the web site 124, the customer can communicate with the merchant 122 by filling out an electronic form or by providing other input (such as by clicking hyperlinks) to get the response fulfilled.

In another embodiment, the merchant 124 is notified explicitly by the advertising service (or other mechanism) at the block 512, and then the merchant 122 directly and actively connects to the customer at the block 514. Explicit notification of the merchant 122 at the block 512 can be implemented in several ways once the customer and the merchant 122 have been correlated at the block 510.

In one embodiment, the merchant 122 may be notified by an automatically generated email (sent from a server at the distribution center 306 or other location, for instance) that can include the customer's contact information and description of the customer request. In another embodiment, the merchant 122 may be notified by a telephone call from the advertising service (such as from a human operator or via an automated message), which may be sent via the PSTN 132 and which provides the customer information needed by the merchant 122. It is understood that other forms of notification can be used as well, such as facsimile, page, screen alert, instant message, etc.

In accordance with one embodiment, a template can be created by the advertising service for the merchant 122. Such a template can contain fields for the customer's contact information and description of requested items. When the merchant 122 is to be notified, a template is completed for the specific customer (by electronically extracting customer and merchant information from a database), and then the completed template is sent to the merchant 122. The completed template can be provided to the merchant 122 as a display screen “pop-up” window or other visual presentation, as a facsimile, as an automated telephone message, etc. In an embodiment, since the merchant 122 is already provided with the customer's contact information in the completed template, the merchant can simply press a button to automatically connect to the customer. Pressing of the button can trigger a speed dial telephone call to the customer, an email to the customer, initiation of a video communication with the customer, etc. In an embodiment, the merchant 122 can subscribe to have this display screen “pop-up” service in which it is provided completed templates.

Connection between the merchant 122 and the customer can be implemented in several ways at the block 514, alternatively or in addition to the techniques described above. According to various embodiments, the merchant 122 can connect to the customer and/or the customer can be connected to the merchant 122. In one embodiment, the customer can be connected to the merchant 122 (or vice versa) by connecting the customer's telephone (such as via the PSTN 132, a computer-integrated telephone, a telephone provided as part of the customer's interactive television service, or some other type of voice communication service) to the merchant's 122 telephone number. In another embodiment, the customer can be connected to the merchant 122 (or vice versa) by linking the customer's computer to the computer or other terminal of the merchant 122 through a network, such as the Internet 302 of FIG. 3.

As described numerous times herein, communication between the merchant 122 and the customer at the block 516 to fulfill the customer's response can utilize many different types of communication media/formats, including a live telephone call between the customer and a service representative of the merchant 122. In accordance with an embodiment of the invention, communication between the customer and the merchant 122 at the block 516 may be conducted by way of video communication, sometimes referred to as “video conferencing.” Such video communication can implement conventional Internet video conferencing techniques in one embodiment. Another embodiment can use video/audio capture and communication techniques similar to those described in U.S. patent application Ser. No. 09/698,298, entitled “SYSTEMS, METHODS, AND DEVICES FOR VIDEO AND AUDIO CAPTURE AND COMMUNICATION,” filed Oct. 27, 2000, which claims priority based on U.S. Provisional Application Serial No. 60/237,013, entitled “SYSTEMS, METHODS, AND DEVICES FOR VIDEO AND AUDIO CAPTURE AND COMMUNICATIONS,” filed Sep. 29, 2000, both of which are owned by the same assignee as the present application and which are incorporated herein by reference.

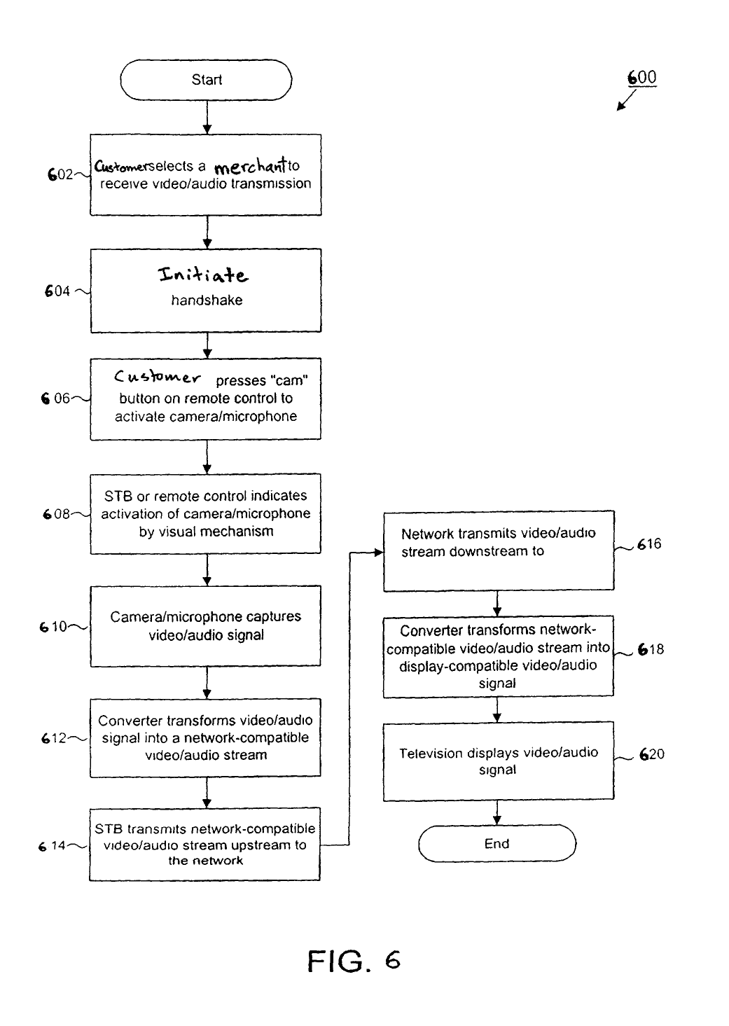

An embodiment of such a video and audio capture and communication technique that can be used during fulfillment of a customer's response to any interactive advertisement, such as the interactive advertisement 402 of FIG. 4, is shown in a flow diagram 600 in FIG. 6. The technique depicted in the flow diagram 600 can be implemented using suitably located web cameras and associated microphones or other audio capture devices. Such a camera/microphone may be mounted on the set top box 152, on the television set 154, integrated in the remote control unit 158, or located elsewhere proximate to the customer. For simplicity of explanation, the flow diagram 600 will be described hereinafter in the context of the customer as the party that initiates a video conference communication with the merchant 122, and it is clear that the described procedures can be applied in the context of the merchant 122 as the party that initiates the video conference communication with the customer.

The flow diagram 600 begins at a block 602 when the customer uses an input device, such as the remote control unit 158 in conjunction with the set top box 152, to select a destination (e.g., the merchant 122) to receive a video/audio transmission. The selection may be performed by entering an identification or network address of the merchant 122, or by clicking on the indicator 404 using the remote control unit 158 in one embodiment. If the identification or network address of the merchant 122 is not known, for example, the set top box 152 may access a name server or directory (not shown) to retrieve a corresponding identification or address of the merchant 122. In one embodiment, the set top box 152 may contain a local directory of addresses, such as the participating merchant list 153 or other list, to which the user frequently sends video/audio transmissions.

Once the set top box 152 has a valid address, it sends a request across the network to the merchant 122. The precise format of the request is not crucial in one embodiment of the invention. The request indicates to the merchant 122 that the user of the set top box 152 desires to send a video/audio transmission.

In response to the request, a receiving terminal of the merchant 122 generates a notification, such as a text message or icon, for display to notify the merchant 122 of the upcoming video/audio transmission. Alternatively, the notification may take the form of an audio signal that is played on a speaker (not shown) of the receiving terminal of the merchant 122.

If the receiving terminal of the merchant 122 is off-line or otherwise not available, the set top box 152 of the customer may wait until a timeout period has expired, after which it notifies the customer that the audio/video transmission cannot be sent. Likewise, if the merchant 122 does not respond, or refuses to receive the transmission a “not-available” signal may be returned to the set top box 152.

If the merchant 122 wishes to receive the video/audio transmission, the merchant 122 may press a suitable button on the receiving terminal, such as an “accept” button, which results in an acceptance signal being returned to the set top box 152. In one embodiment, the set top box 152 generates, in response to receiving the acceptance signal, a video or audio acceptance message to notify the customer that permission for the video/audio transmission has been granted.

At a block 604, the set top box 152 and the receiving terminal of the merchant 122 may then initiate a handshake procedure to establish a communication protocol. In this case, the set top box 152 and the receiving terminal may negotiate a new protocol or reaffirm an existing protocol for video/audio communication. The appropriate protocol may need to be determined in one embodiment if the set top box 152 and the receiving terminal of the merchant 122 have different video/audio conferencing capabilities. For example, the receiving terminal of the merchant 122 may be capable of video conferencing at a lower resolution (or frame rate), so the communication protocol is established as is suitable for this lower resolution (or frame rate). The communication protocol used may also depend on the bandwidth and/or reliability of the connection between the set top box 152 and the receiving terminal of the merchant 122.

At this point, an active communication link is established between the set top box 152 and the receiving terminal of the merchant 122 across the network. In one embodiment, the customer then activates, at a block 606, a camera and/or microphone (not shown) by pressing, for example, a “cam” button on the remote control unit 158. In one implementation, the remote control unit 158 and/or the set top box 152 indicates at a block 608 activation of the camera by a visual mechanism, such as an activity indicator (e.g., a light-emitting diode or LED). Thereafter at a block 610, the camera and/or microphone captures a video and/or audio signal (which is transmitted to the set top box 152).

At a block 612, a converter within the set top box 152 then transforms the captured video/audio signal into a network-compatible video/audio stream for transmission over the network, such as over the cable network 134 and/or over the Internet 302. Thereafter at a block 614, the network-compatible video/audio stream is transmitted upstream to the network. As can be noted with reference to FIGS. 1-3, the communication path for the upstream transmission may involve one or more head-ends, communication networks, and/or the Internet 302, using conventional routing techniques.

In one embodiment, the network-compatible video/audio stream is then transmitted at a block 616 downstream from the network to the receiving terminal of the merchant 122. Thereafter, the network-compatible video/audio stream is transformed into a display-compatible video/audio signal at a block 618 for display on a television or display screen of the merchant 122 at a block 620.

In a like manner, the receiving terminal of the merchant 122 may transmit video/audio information to the set top box 152 of the customer. Indeed, in one embodiment, multiple video/audio streams may be received and transmitted simultaneously by any particular terminal. Multiple video streams received by any particular terminal may be displayed on a display screen at the same time using picture-in-picture (PIP) techniques. Likewise, multiple audio streams may be mixed for playback on an appropriate terminal. In an embodiment MPEG PIDs may be used to allocate and identify requisite video streams. To provide for privacy, the customer may see the merchant 122 but not vice-versa in an embodiment. With this privacy feature, the merchant 122 may listen to the customer via telephone or audio-conferencing, for example.

Of course, the above-described technique depicted by the flow diagram 600 is only one possible technique for video and audio capture and communication within the scope of the invention. In other embodiments, the set top box 152 may transmit a video/audio stream to the receiving terminal of the merchant 122 (or vice versa) without waiting for an acceptance signal. The receiving terminal of the merchant 122 (or the set top box 152 of the customer) may record all incoming transmissions in a digital storage device. Thereafter, the merchant 122 may review the stored video/audio streams and select which stream, if any, to display at a convenient time. This facilitates a form of “videomail.”

In yet another embodiment, the set top box 152 may be pre-configured to transmit video/audio information to the receiving terminal of the merchant 122, which has previously granted permission to receive the transmission. Accordingly, the user of the set top box 152 may simply press the “cam” button to immediately capture video/audio information and transmit the same to the receiving terminal for immediate display.

The receiving terminal of the merchant 122 and/or the client terminal of the customer may comprise a PC or other device with a connection to the Internet 302. Such other devices may include Internet appliances, PDAs, Internet-enabled cellular telephones, and the like. If these devices have varying video-conferencing capabilities, a handshaking procedure as described above can be used in determining a proper communication protocol.

In conclusion, an embodiment of the invention allows an advertising service to present an interactive advertisement to a customer, such as via a television commercial. If the customer indicates an interest in the advertised product by responding to the advertisement, then the advertising service or other mechanism detects a response to the interactive advertisement, identifies the customer, correlates the customer to a merchant, and then automatically connects the customer to the merchant (or triggers connection of the merchant to the customer). Thereafter, the merchant can fulfill the customer's response in a personalized and interactive manner.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

For example, while various embodiments have been described above as involving viewing of the television commercial 402 and then processing the customer's response when the customer “clicks” the indicator 404, other types of interactive advertising and processing of customer responses are possible. For instance, the customer can receive an interactive advertisement via telephone, or the customer can respond to a visual interactive advertisement via telephone. With the use of voice recognition, speech processing, or other audio processing software, the customer's spoken response can be detected by the advertising service and then electronically processed (such as by identifying key words in the customer's response). Subsequently, the advertising service can perform additional correlation between the processed response and merchant information to identify a merchant that can service the customer, and then notify that merchant as to the origin and subject matter of the customer's response.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method, comprising:
detecting a response, to an interactive advertisement, sent from a client terminal of a customer;
identifying customer information from the detected response;
correlating the identified customer information to merchant information to identify a specific merchant; and
triggering notification of the identified specific merchant to allow communication between the customer and the specific merchant.

2. The method of claim 1 wherein the interactive advertisement is provided to the customer via an interactive video casting system.

3. The method of claim 2 wherein the interactive video casting system comprises an interactive television system.

4. The method of claim 1 wherein identifying the customer information from the detected response comprises identification of an identification code corresponding to the client terminal.

5. The method of claim 1, further comprising correlating a characteristic associated with the interactive advertisement to the merchant information.

6. The method of claim 5 wherein the characteristic associated with the interactive advertisement comprises one of a channel in which the interactive advertisement was provided, a time in which the interactive advertisement was provided, or a time in which the customer responded to the interactive advertisement.

7. The method of claim 1 wherein the communication between the specific merchant and the customer is conductable via video communication.

8. The method of claim 1 wherein the interactive advertisement is capable of being provided via a telephone, and wherein identifying customer information from the detected response comprises using an audio processing technique to identify words spoken by the customer into the telephone as part of the response.

9. The method of claim 1 wherein triggering notification of the identified specific merchant comprises:
completing a template including at least some of the identified customer information and the merchant information; and
sending the completed template to the identified specific merchant.

10. The method of claim 1 wherein triggering notification of the identified specific merchant comprises sending one of a telephone message, voicemail message, page message, email message, instant message, facsimile message, wireless device message, or web site message to the specific merchant to notify the specific merchant to contact the customer.

11. The method of claim 1 wherein triggering notification of the identified specific merchant to allow communication between the customer and the specific merchant comprises, based on trigger information that specifies an address of the specific merchant that is capable of being sent along with the interactive advertisement, redirecting the client terminal to the address of the merchant specified in the trigger information.

12. The method of claim 1 wherein the interactive advertisement is capable of being provided as part of an interactive video casting transmission, the method further comprising sending an indicator displayable along with the interactive advertisement, wherein detecting the response to the interactive advertisement comprises detecting customer activation of the indicator.

13. The method of claim 1, further comprising registering a plurality of merchants for interactive advertisements, including obtaining corresponding merchant information from the registered merchants.

14. The method of claim 1 wherein communication between the identified specific merchant and the customer is conductable via one of a telephone, voicemail, page, email, instant message, facsimile, wireless device, video communication, computer linking, or web site.

15. An article of manufacture, comprising:
a machine-readable medium having stored there on instructions to:
detect a response, to an interactive advertisement, sent from a client terminal of a customer;
identify customer information from the detected response;
correlate the identified customer information to merchant information to identify a specific merchant; and
trigger notification of the identified specific merchant to allow communication between the customer and the specific merchant.

16. The article of manufacture of claim 15 wherein instructions to identify the customer information from the detected response include instructions stored on the machine-readable medium to identify an identification code corresponding to the client terminal.

17. The article of manufacture of claim 15 wherein the machine-readable medium further includes instructions stored thereon to correlate a characteristic associated with the interactive advertisement to the merchant information.

18. The article of manufacture of claim 15 wherein the interactive advertisement is capable of being provided via a telephone, and wherein the instructions to identify customer information from the detected response comprise audio processing instructions to identify words spoken by the customer into the telephone as part of the response.

19. The article of manufacture of claim 15 wherein the instructions to trigger notification of the identified specific merchant include instructions stored on the machine-readable medium to:
complete a template including at least some of the identified customer information and the merchant information; and
send the completed template to the identified specific merchant.

20. The article of manufacture of claim 15 wherein the interactive advertisement is capable of being provided as part of an interactive video casting transmission, the machine-readable medium further including instructions stored thereon to send an indicator displayable along with the interactive advertisement, wherein the instructions to detect the response to the interactive advertisement include instructions stored on the machine-readable medium to detect customer activation of the indicator.

21. The article of manufacture of claim 15 wherein the instructions to trigger notification of the identified specific merchant to allow communication between the customer and the specific merchant comprises, based on trigger information that specifies an address of the specific merchant that is capable of being sent along with the interactive advertisement, instructions stored on the machine-readable medium to redirect the client terminal to the address of the merchant specified in the trigger information.

22. A system, comprising:
a server capable to detect a response, to an interactive advertisement, received from a client terminal of a customer, and capable to identify customer information from the detected response;
a storage unit coupled to the server to store customer information and merchant information, the server coupled to access the storage unit to correlate the identified customer information to merchant information stored therein to identify a specific merchant; and
a communication device communicatively coupled to the server to trigger a notification of the identified specific merchant to allow communication between the customer and the specific merchant.

23. The system of claim 22 wherein the communication device comprises one of a telephone device, voicemail device, paging, email device, instant message device, facsimile device, wireless device, or web site device capable to send the notification to the specific merchant to contact the customer.

24. The system of claim 22 wherein the server is capable to complete a template including at least some of the identified customer information and the merchant information and to send the completed template to the identified specific merchant via the communication device.

25. The system of claim 22, further comprising an interactive video casting network coupleable to the server and capable to provide the interactive advertisement to the customer.
